(19) United States
(12) Patent Application Publication
(10) Pub. No.: US 2010/0127761 A1
(43) Pub. Date: May 27, 2010

(54) CHARGE PUMP CIRCUIT AND SEMICONDUCTOR MEMORY DEVICE INCLUDING THE SAME

(75) Inventor: Tatsuya MATANO, Chuo--ku (JP)

Correspondence Address: SUGHRUE MION, PLLC, 2100 PENNSYLVANIA AVENUE, N.W., SUITE 800, WASHINGTON, DC, 20037, US

(73) Assignee: Elpida Memory, Inc., Tokyo (JP)

(21) Appl. No.: 12/626,820

(22) Filed: Nov. 27, 2009

(30) Foreign Application Priority Data
Nov. 27, 2008 (JP) 2008-302536

(51) Int. Cl. H02M 3/07; H02M 3/06

(52) U.S. Cl. 327/536

(57) ABSTRACT

A charge pump circuit includes a plurality of capacitors connected in series via switch circuits, a plurality of pre-charge circuits that pre-charge the capacitors, respectively, and a control circuit that controls the switch circuits and the pre-charge circuits. The control circuit sequentially deactivates the pre-charge circuits from a pre-charge circuit allocated to the last stage capacitor to a pre-charge circuit allocated to the first stage capacitor in this order. Deactivation of each of the pre-charge circuits is performed after pre-charge of a parasitic capacitance component included in a latter stage capacitor than a corresponding capacitor is completed. With this method, a charge loss due to a parasitic capacitance is reduced, and at the same time, pre-charge of a parasitic capacitance component that is sequentially increased can be reliably performed.

### BACKGROUND OF THE INVENTION

1. Field of the Invention

The present invention relates to a charge pump circuit and a semiconductor memory device including the same, and more particularly relates to a multistage charge pump circuit including a plurality of capacitors and a semiconductor memory device including the same.

2. Description of Related Art

Some semiconductor devices require a boost potential that is higher than a power source potential supplied from the outside or a negative potential that is lower than a ground potential. Such semiconductor devices include a built-in charge pump circuit for generating a boost potential or a negative potential (see Japanese Patent Application Laid-open Nos. 2000-3598, 2003-33007 and 2004-64963).

The charge pump circuit is a power supply circuit that performs a boost operation based on pumping using capacitors, and can perform a large step-up by using a plurality of capacitors. A multistage charge pump circuit that uses a plurality of capacitors is roughly divided into a type in which the capacitors are connected in parallel (a parallel connection method) and a type in which the capacitors are connected in series (a series connection method).

The parallel connection method has an advantage in that the boost efficiency is high because a charge loss due to a parasitic capacitance is low. However, because the later stage capacitor has a higher voltage applied between a pair of capacitor electrodes, there is a problem that a withstanding voltage of a capacitor insulating film included in the later stage capacitor becomes insufficient. To solve this problem, it is required to increase the withstanding voltage by increasing the thickness of the capacitor insulating film included in the later stage capacitor. However, because the capacitance decreases as the thickness of the capacitor insulating film increases, areas of the capacitor electrodes need to be increased to achieve a desired capacitance, which results in another problem that the occupied area of the electrodes increases.

On the other hand, the series connection method does not have a problem of insufficient withstanding voltage of the capacitor insulating film, because all capacitors have the same level of a voltage applied between a pair of capacitor electrodes as the level of the power source voltage. However, in the series connection method, there is a problem that the boost efficiency is relatively low because the charge loss due to the parasitic capacitance is high.

Therefore, there has been a demand for a development of a charge pump circuit of the series connection method in which a charge loss due to a parasitic capacitance is reduced.

### SUMMARY

The present invention seeks to solve one or more of the above problems, or to improve upon those problems at least in part.

In one embodiment, there is provided a charge pump circuit comprising: a plurality of capacitors including a first stage capacitor and a last stage capacitor connected in series via switch circuits; a plurality of pre-charge circuits that pre-charge the capacitors, respectively; and a control circuit that controls the switch circuits and the pre-charge circuits, wherein the control circuit sequentially deactivates the pre-charge circuits from a pre-charge circuit assigned to the last stage capacitor to a pre-charge circuit assigned to the first stage capacitor in this order, such that the control circuit deactivates each of the pre-charge circuits after pre-charge of a parasitic capacitance component included in a latter stage capacitors with respect to a corresponding capacitor is completed, and the control circuit supplies a drive signal to the first stage capacitor after the pre-charge circuit assigned to the first stage capacitor is deactivated so as to generate a boost voltage in the last stage capacitor.

In another embodiment, there is provided a charge pump circuit that includes: N number of capacitors connected in series via switch circuits; N number of pre-charge circuits that pre-charge the N number of capacitors, respectively; and a control circuit that controls the switch circuits and the pre-charge circuits, wherein the control circuit sequentially deactivates the pre-charge circuits from a first pre-charge circuit to an Nth pre-charge circuit in this order, and sets an interval between a timing at which an (i+1)th pre-charge circuit is deactivated and a timing at which an (i+2)th pre-charge circuit is deactivated to be longer than an interval between a timing at which an ith pre-charge circuit is deactivated and a timing at which the (i+1)th pre-charge circuit is deactivated, where i is an integer from 1 to N−2.

In still another embodiment, there is provided a charge pump circuit that includes: N number of capacitors connected in series via switch circuits; N number of pre-charge circuits that pre-charge the N number of capacitors, respectively; and a control circuit that controls the switch circuits and the pre-charge circuits, wherein the control circuit sequentially deactivates the pre-charge circuits from a first pre-charge circuit to an Nth pre-charge circuit in this order, and a current drive capability of a (j+1)th pre-charge circuit is larger than a current drive capability of a jth pre-charge circuit, where j is an integer from 1 to N−1.

In still another embodiment, there is provided a semiconductor memory device that includes: a word line; a bit line; a memory cell for which a current path is formed with the bit line in response to activation of the word line; a write circuit that supplies a write current to the bit line; and the above described charge pump circuit that supplies an operation voltage to the write circuit, wherein the memory cell includes a phase change element in which a phase state is changed by the write current supplied from the bit line.

According to the present invention, because the pre-charge circuits are sequentially deactivated, the charge loss due to the parasitic capacitance can be reduced. Further, by setting the longer pre-charge time or the higher pre-charge capability to the former pre-charge circuit in which the more load is placed due to the parasitic capacitance, it is possible to reliably perform pre-charge on the parasitic capacitance component that is sequentially increased. The charge pump circuit according to the present invention is not limited to a circuit for generating a boost potential higher than the power source potential, but can be applied to a circuit for generating a negative potential lower than a ground potential.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a circuit diagram of a charge pump circuit 100 according to a first embodiment of the present invention;

FIG. 2 is a diagram showing an operation state of the charge pump circuit 100;

FIG. 3 is a diagram showing another operation state of the charge pump circuit 100;

FIG. 4 is a diagram showing still another operation state of the charge pump circuit 100;

FIG. 5 is a detailed circuit diagram of the charge pump circuit 100 when N=3;

FIG. 6 is an operation waveform chart of the charge pump circuit 100;

FIG. 7 is a circuit diagram of a charge pump circuit 200 according to a second embodiment of the present invention;

FIG. 8 is a circuit diagram of a charge pump circuit 300 according to a third embodiment of the present invention;

FIG. 9 is a circuit diagram of a charge pump circuit 400 according to a fourth embodiment of the present invention;

FIG. 10 is a block diagram of a semiconductor memory device 500 according to a fifth embodiment of the present invention; and

FIG. 11 is a circuit diagram wherein the capacitor in each embodiment of the present invention is shown by using a MOS transistor.

### DETAILED DESCRIPTION OF THE EMBODIMENTS

Preferred embodiments of the present invention will be explained below in detail with reference to the accompanying drawings.

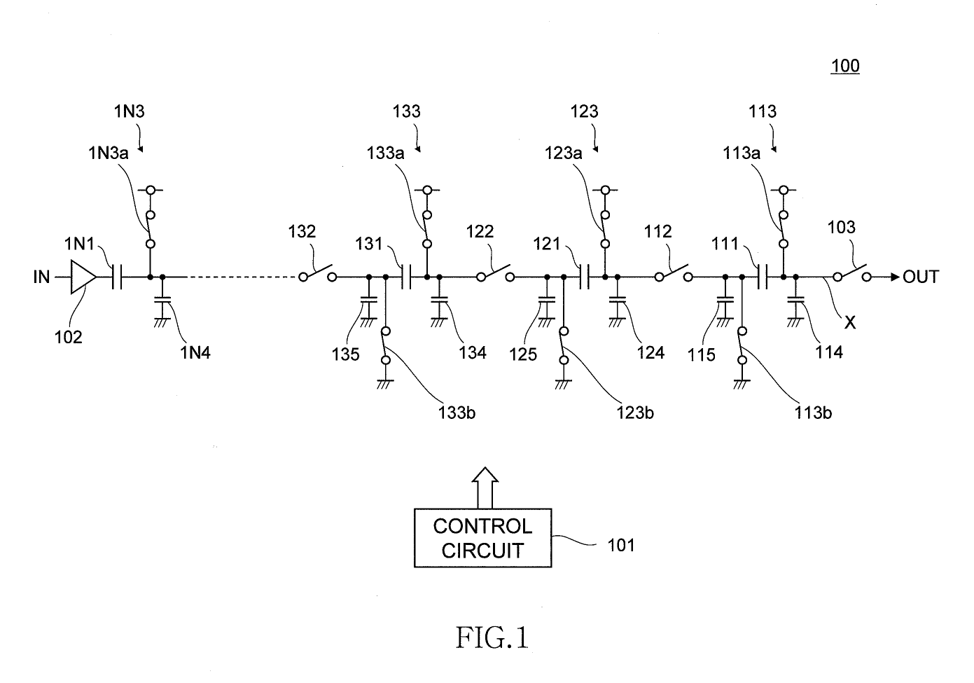

FIG. 1 is a circuit diagram of a charge pump circuit 100 according to a first embodiment of the present invention.

As shown in FIG. 1, the charge pump circuit 100 according to the first embodiment includes N number of capacitors 111, 121, 131, . . . , 1N1 connected in series, and switch circuits 112, 122, 132, . . . each connected between adjacent capacitors. N number of the pre-charge circuits 113, 123, 133, . . . , 1N3 are connected to the capacitors 111, 121, 131, . . . , 1N1, respectively. During a period in which a corresponding switch circuit is turned off, a corresponding capacitor is charged. For example, the pre-charge circuit 113 includes a transistor 113a that supplies a power source potential VDD to one terminal of the capacitor 111 and a transistor 113b that supplies a ground potential GND to another terminal of the capacitor 111. When the transistors 113a and 113b are turned on in a state where the switch circuit 112 is turned off, the capacitor 111 is pre-charged to VDD.

Operations of the switch circuits 112, 122, 132, . . . and the pre-charge circuits 113, 123, 133, . . . , 1N3 are controlled by a control circuit 101.

An operation of the charge pump circuit 100 according to the first embodiment is explained next.

A basic operation of the charge pump circuit 100 is as follows. First, as shown in FIG. 1, the pre-charge circuits 113, 123, 133, . . . , 1N3 are activated in a state where all the switch circuits 112, 122, 132, . . . are turned off, thus pre-charging all the capacitors 111, 121, 131, . . . , 1N1 to VDD. Subsequently, the pre-charge circuits 113, 123, 133, . . . , 1N3 are deactivated, the switch circuits 112, 122, 132, . . . are turned on, and a drive signal IN is supplied to the first stage capacitor 1N1 via a buffer 102, and then a node X is pumped to a voltage that is higher than the power source voltage. Finally, when a switch circuit 103 is turned on, a boost voltage higher than the power source voltage is output to an output OUT.

However, each of the capacitors has a parasitic capacitance component. For example, a parasitic capacitance component 114 that is caused by the transistor 113a and the like exists at the one terminal of the capacitor 111, and a parasitic capacitance component 115 that is caused by the transistor 113b and the like exists at the other terminal of the capacitor 111. Therefore, if the pre-charge circuits 113, 123, 133, . . . , 1N3 are deactivated at the same time, a portion of the charges is consumed for charging the parasitic capacitance components. That is, a large charge loss occurs due to the parasitic capacitance, and as a result, it is not possible to obtain a sufficient boost voltage.

To solve the above problem, in the charge pump circuit 100 according to the first embodiment, the pre-charge circuits 113, 123, 133, . . . , 1N3 are not simultaneously deactivated, but deactivated sequentially from the last stage side, thus pre-charging the parasitic capacitance. A method of sequentially deactivating pre-charge circuits from the last stage side in a charge pump circuit of a series connection method is described in Japanese Patent Application Laid-open Publication No. 2004-64963. However, in the method described in the patent document, because intervals for deactivating the pre-charge circuits are constant and there is no difference in performance between pre-charge circuits in each of the stages, pre-charge of the parasitic capacitance that is sequentially increased cannot be performed properly. The present invention also solves such a problem. Details thereof are explained below.

First, as shown in FIG. 1, all the capacitors 111, 121, 131, . . . , 1N1 are pre-charged to VDD by activating the pre-charge circuits 113, 123, 133, . . . , 1N3 in a state where all the switch circuits 112, 122, 132, . . . are turned off.

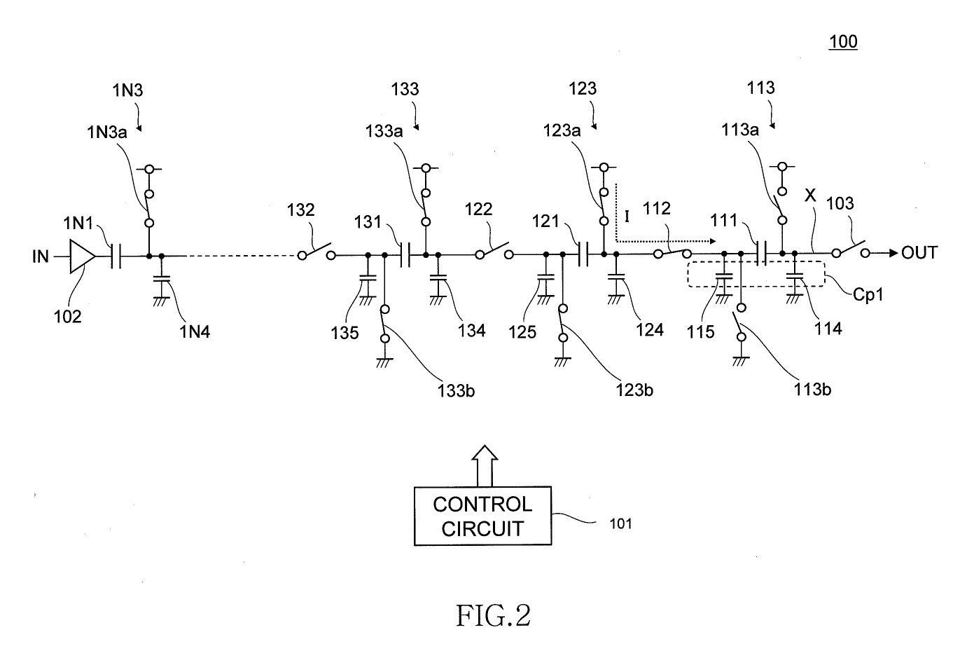

Next, as shown in FIG. 2, the first switch circuit 112 is turned on, and a state of the pre-charge circuit 113 is changed from an activation state to a deactivation state. That is, the transistors 113a and 113b are turned off. With this operation, the capacitor 111 is pumped, and the node X is ideally boosted to VDD×2. However, because the parasitic capacitance components 114 and 115 exist in the capacitor 111, a portion of the charge is consumed for charging the parasitic capacitance components. However, in the first embodiment, because the pre-charge circuit 123 at the former stage is still in an activation state at this moment, a current I flows via a transistor 123a, so that a charge is replenished. Therefore, a voltage drop due to the existence of the parasitic capacitance components is greatly suppressed. In this case, a total of the parasitic capacitance to be pre-charged is Cp1. The former stage means a stage on a side relatively close to the buffer 102. On the other hand, the latter stage means a stage on a side relatively close to the switch circuit 103.

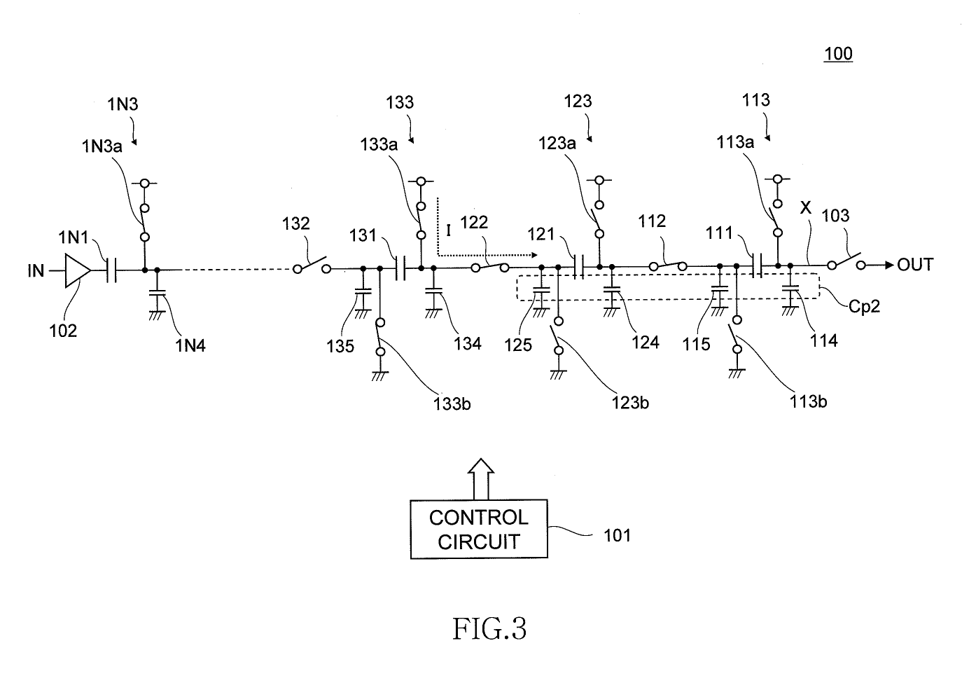

After completing pre-charge of the parasitic capacitance Cp1, as shown in FIG. 3, the second switch circuit 122 is turned on, and a state of the pre-charge circuit 123 is changed from an activation state to a deactivation state. That is, transistors 123a and 123b are turned off. With this operation, the capacitors 111 and 121 are pumped, and the node X is ideally boosted to VDD×3. Also in this case, because the pre-charge circuit 133 at the former stage is still in an activation state at this moment, the current I flows via a transistor 133a, so that a charge is replenished. Therefore, a voltage drop due to the existence of parasitic capacitance components is greatly suppressed. In this case, a total of the parasitic capacitance components 114, 115, 124, and 125 to be pre-charged is Cp2 (>Cp1).

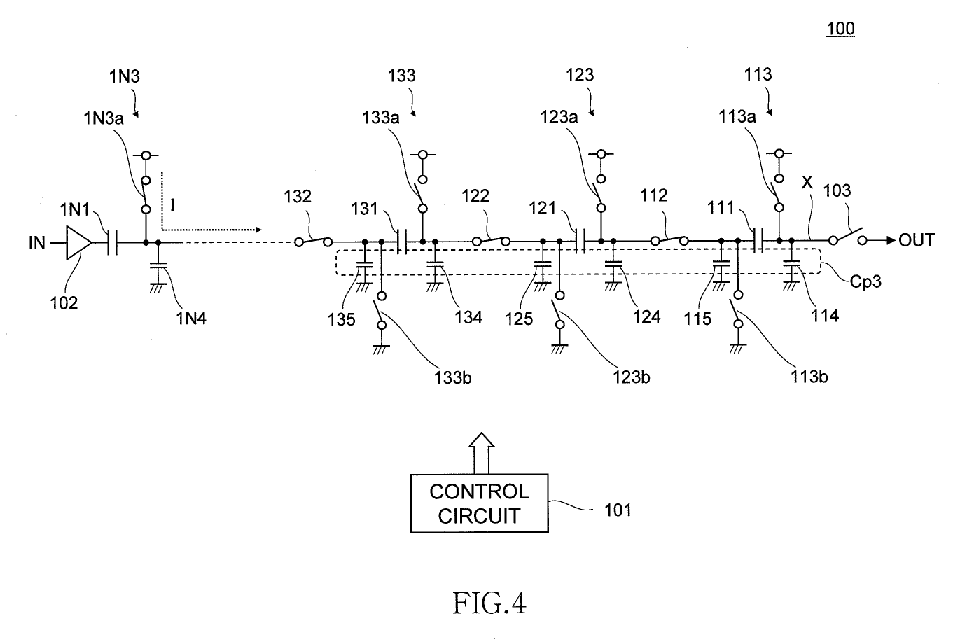

Thereafter, the pre-charge circuits are sequentially deactivated, and the switch circuits are sequentially turned on. In a state where all the switch circuits are turned on, as shown in FIG. 4, the current I flows via a transistor 1N3a, and all the parasitic capacitance components including the parasitic capacitance components 114, 115, 124, 125, 134, and 135 are pre-charged. A total of the parasitic capacitance is Cp3 (>Cp2). With this operation, all the capacitors and the parasitic capacitance components are in a state where they are pre-charged.

When the drive signal IN is supplied to the first stage capacitor 1N1 via the buffer 102 after turning off the transistor 1N3a, the node X is boosted ideally to VDD×(N+1). If the switch circuit 103 is turned on in this state, a boost voltage that is higher than the power source voltage is output to the output OUT.

In this manner, in the first embodiment, because the pre-charge circuits are sequentially deactivated in the order from the pre-charge circuit allocated to the last stage capacitor 111 to the pre-charge circuit allocated to the first stage capacitor 1N1, the charge consumed for charging the parasitic capacitance component is replenished. In this case, as the deactivation of the pre-charge circuits proceeds, the parasitic capacitance component that is a target of the charge replenish is sequentially increased, as described above, so that the time required for pre-charging the parasitic capacitance increases. Therefore, the control circuit 101 performs a control in such a manner that an interval between a timing at which the (i+1)th stage pre-charge circuit is deactivated and a timing at which the (i+2)th stage pre-charge circuit is deactivated is longer than an interval between a timing at which the ith stage pre-charge circuit is deactivated and a timing at which the (i+1)th stage pre-charge circuit is deactivated, where i is an integer from 1 to N−2. With this operation, it is possible to pre-charge the parasitic capacitance that is sequentially increased with the deactivation of the pre-charge circuit in a proper manner without waste.

Alternatively, a design can be taken in such a manner that a current drive capability of the (j+1)th stage pre-charge circuit is larger than a current drive capability of the jth stage pre-charge circuit, where j is an integer from 1 to N−1. With this method, it is possible to pre-charge the parasitic capacitance component that is sequentially increased in a proper manner while keeping the intervals for deactivating the pre-charge circuits constant.

The circuit according to the first embodiment is described below in more detail with reference to an example where N=3.

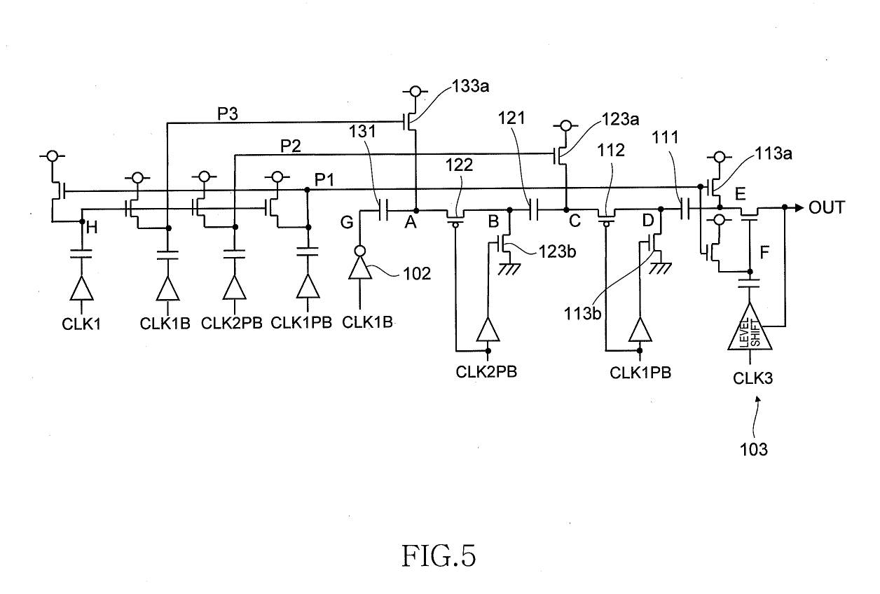

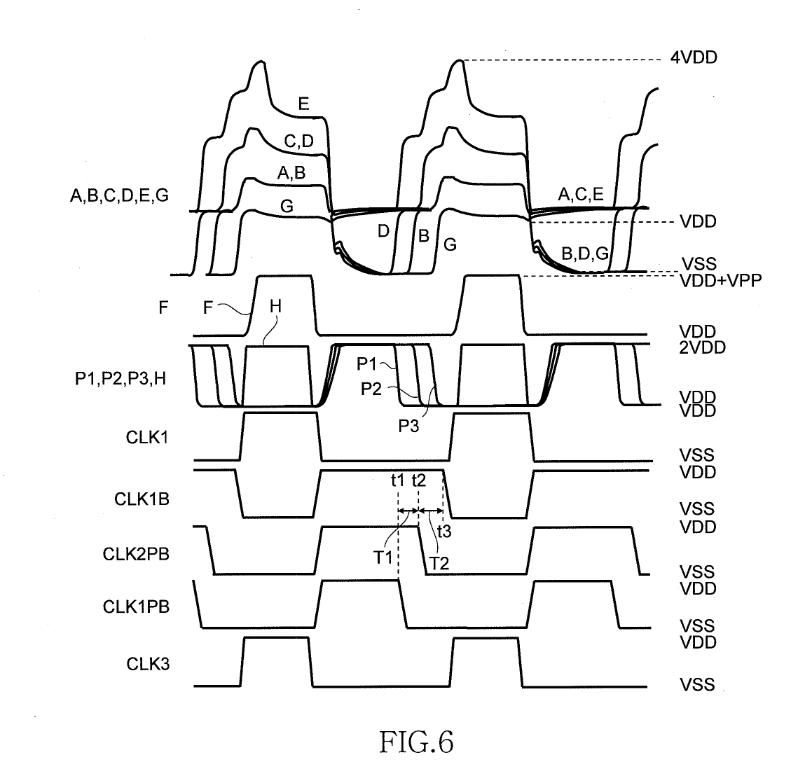

FIG. 5 is a detailed circuit diagram of the charge pump circuit 100 when N=3, and FIG. 6 is an operation waveform chart of the charge pump circuit 100.

As shown in FIG. 5, the pre-charge circuit 113 (the transistors 113a and 113b) is controlled by a clock signal CLK1PB, the pre-charge circuit 123 (the transistors 123a and 123b) is controlled by a clock signal CLK2PB, and the pre-charge circuit 133 (the transistor 133a) is controlled by a clock signal CLK1B. When the waveforms of the clock signals are set to the ones shown in FIG. 6, the charge pump voltage is output to the output OUT in synchronization with a cycle in which the level of a clock signal CLK1 is High.

The control is performed in such a manner that an interval T2 from a timing t2 at which the level of the clock signal CLK2PB is changed to Low to a timing t3 at which the level of the clock signal CLK1B is changed to Low is longer than an interval T1 from a timing t1 at which the level of the clock signal CLK1PB is changed to Low to a timing t2 at which the level of the clock signal CLK2PB is changed to Low (T1<T2). With this control, it is possible to reliably perform pre-charge of the parasitic capacitance component that is sequentially increased without waste.

Although a charge pump circuit of the series connection method has been explained above as an example, the present invention can also be applied to a charge pump circuit of a combined type in which a charge pump unit of the parallel connection method and a charge pump unit of the series connection method are combined. An embodiment of a charge pump circuit of such a combined type is explained below.

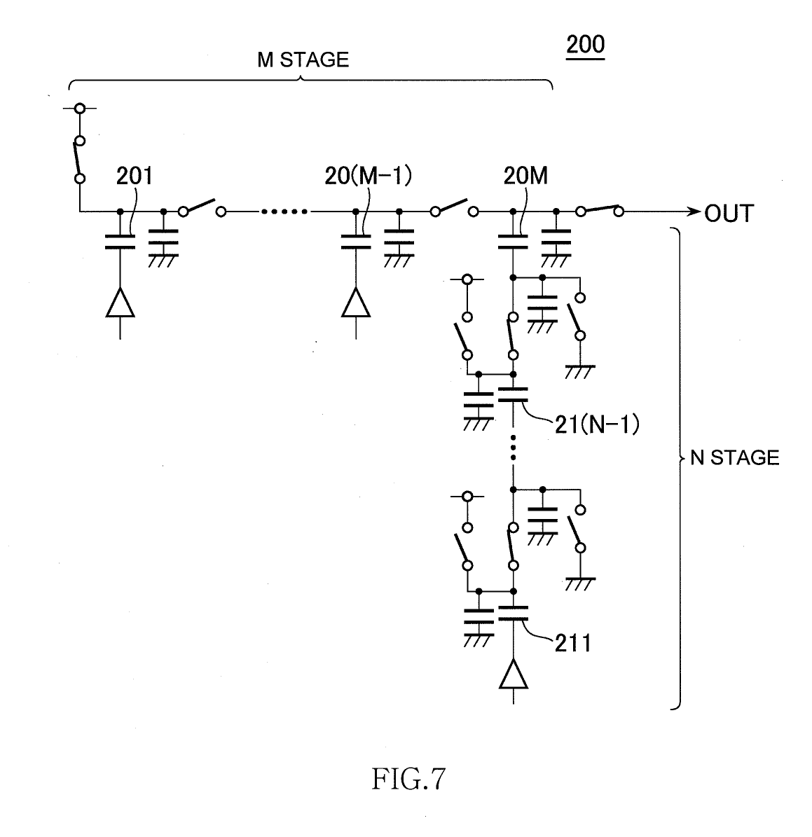

FIG. 7 is a circuit diagram of a charge pump circuit 200 according to a second embodiment of the present invention.

As shown in FIG. 7, the charge pump circuit 200 according to the second embodiment includes an M-stage charge pump unit of the parallel connection method (where M is an integer equal to or larger than 2) and an N-stage charge pump unit of the series connection method (where N is an integer equal to or larger than 2). That is, the M-stage charge pump unit includes M number of capacitors 201 to 20M connected in parallel, and the N-stage charge pump unit includes N number of capacitors 211 to 20M connected in series. The capacitor 20M that forms the last stage of the charge pump unit of the parallel connection method is shared by the charge pump unit of the series connection method. In the charge pump unit of the series connection method, the pre-charge circuits are sequentially deactivated in the same manner as in the first embodiment. Further, the intervals for deactivating the pre-charge circuits are set to be sequentially increased, or the larger current drive capability is set to the former pre-charge circuit.

With the charge pump circuit 200 according to the second embodiment, it is possible to achieve a higher boost potential (ideally, VDD×(M+N)). Furthermore, the voltage applied between both electrodes of the last stage capacitor 20M is suppressed to VDD×M. In the second embodiment, the magnitude relationship between M and N is not particularly limited.

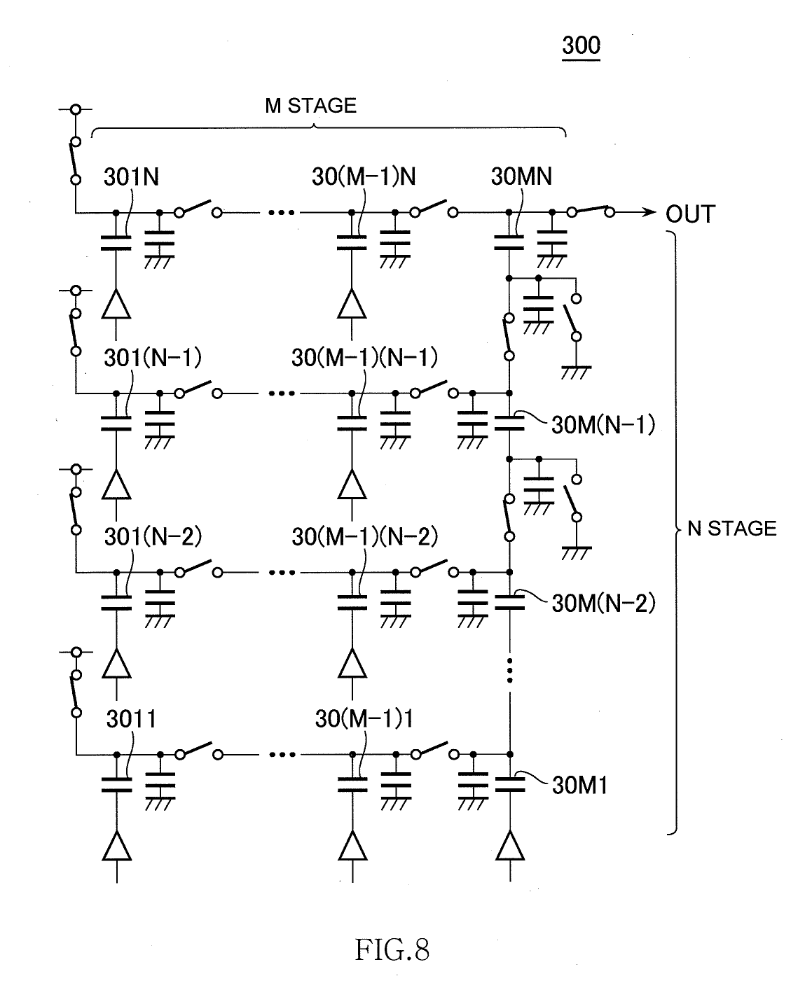

FIG. 8 is a circuit diagram of a charge pump circuit 300 according to a third embodiment of the present invention.

As shown in FIG. 8, the charge pump circuit 300 according to the third embodiment includes N number of M-stage charge pump units of the parallel connection method, with each of the last stages forming an N-stage charge pump unit of the series connection method. That is, each of the M-stage charge pump units includes M number of capacitors 301i to 30Mi (where i=1 to N), and the capacitors 30M1 to 30MN forming the last stages of the M-stage charge pump units, respectively, are connected in series. In the charge pump unit of the series connection method, the pre-charge circuits are sequentially deactivated in the same manner as in the first embodiment. Further, the intervals for deactivating the pre-charge circuits are set to be sequentially increased, or the larger current drive capability is set to the former pre-charge circuit.

With the charge pump circuit 300 according to the third embodiment, it is possible to achieve an even higher boost potential (ideally, VDD×(M×N+1); however, it becomes a lower potential because of the parasitic capacitance Cp and the output voltage dependency). Furthermore, because N number of charge pump voltages of VDD×(M+1) are generated ideally by the M-stage charge pump units of the parallel connection method and the charge pump voltages thus generated are used in pumping by the series connection method, the voltage applied to both electrodes of the last stage capacitor 30MN is suppressed to VDD×M in the same manner as the charge pump circuit 200 according to the second embodiment. Although the number of stages of the N number of charge pump units of the parallel connection method is M in the third embodiment, the number of the stages is not necessarily to be M.

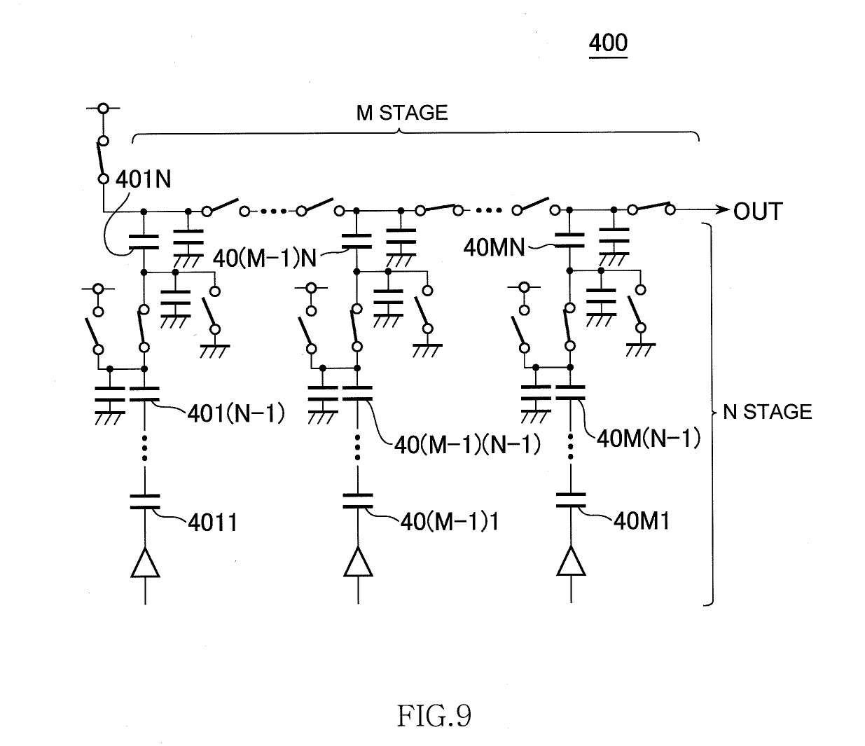

FIG. 9 is a circuit diagram of a charge pump circuit 400 according to a fourth embodiment of the present invention.

As shown in FIG. 9, the charge pump circuit 400 according to the fourth embodiment includes M number of N-stage charge pump units of the series connection method, with each of the last stages forming an M-stage charge pump unit of the parallel connection method. That is, each of the N-stage charge pump units includes N number of capacitors 40j1 to 40jN (where j=1 to M), and the capacitors 401N to 40MN forming the last stages of the N-stage charge pump units, respectively, are connected in parallel. In the charge pump unit of the series connection method, the pre-charge circuits are sequentially deactivated in the same manner as in the first embodiment. Further, the intervals for deactivating the pre-charge circuits are set to be sequentially increased, or the larger current drive capability is set to the former pre-charge circuit.

With the charge pump circuit 400 according to the fourth embodiment, it is possible achieve to a boost potential as high as that of the charge pump circuit 300 according to the third embodiment (ideally, VDD×(M×N+1); however, it becomes a lower potential because of the parasitic capacitance Cp and the output voltage dependency). Furthermore, the voltage applied between both electrodes of the last stage capacitor 40MN is suppressed to VDD×{(M−1)×N+1}. In addition, although the number of stages of the M number of charge pump units of the series connection method is N in the fourth embodiment, the number of the stages is not necessarily to be N.

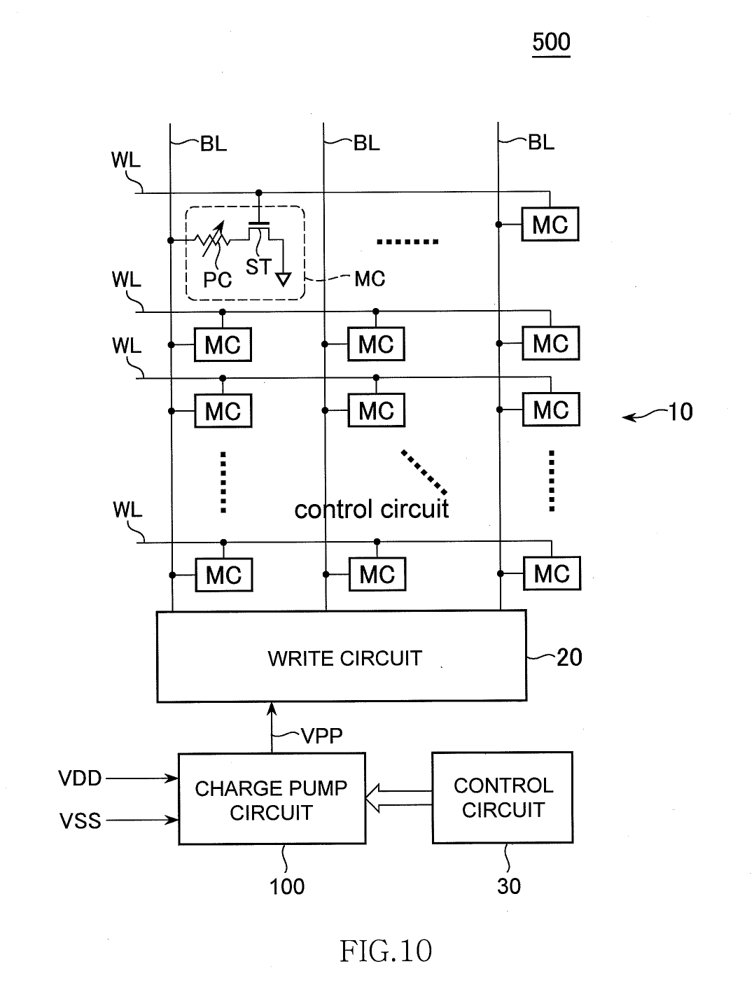

FIG. 10 is a block diagram of a semiconductor memory device 500 according to a fifth embodiment of the present invention.

As shown in FIG. 10, the semiconductor memory device 500 according to the fifth embodiment includes a memory cell array 10, a write circuit 20, a charge pump circuit 100, and a control circuit 30. The control circuit 30 supplies various clock signals (see FIGS. 5 and 6) required for an operation of the charge pump circuit 100 to the charge pump circuit 100. A circuit configuration of the charge pump circuit 100 is as stated above.

The memory cell array 10 includes a plurality of word lines WL, a plurality of bit lines BL, and a plurality of memory cells MC each arranged at a point at the intersection of each of the word lines WL with each of the bit lines BL. The memory cell MC has a configuration in which a series circuit of a phase change element PC of which the phase state is changed and a select transistor ST is connected to a corresponding one of the bit line BL, and a gate electrode of the select transistor ST is connected to a corresponding one of the word line WL. With this configuration, when a predetermined word line WL is activated, a current path is formed between a corresponding one of the bit line BL and the phase change element PC, and a write current or a read current can be supplied via the bit line BL.

The supply of the write current is performed by the write circuit 20. When the memory cell MC that is a write target is set to a high resistance state (a reset state), the write circuit 20 supplies a reset current to the bit line BL, thus heating a phase change material included in the phase change element PC to a temperature above its melting point. After the heating, the phase change element PC becomes an amorphous state by being rapidly cooled. On the other hand, when the memory cell MC that is the write target is set to a low resistance state (a set state), the write circuit 20 supplies a set current to the bit line BL, thus heating the phase change material included in the phase change element PC to a temperature above its crystallizing point and below its melting point. Thereafter, the phase change element PC becomes a crystalline state by being slowly cooled.

To change the phase state of the phase change element PC by applying the reset current and the set current, it is necessary to boost the voltage of the bit line BL to a relatively high voltage. Therefore, the write circuit 20 receives a boost potential VPP from the charge pump circuit 100, and generates the reset current and the set current using the boost potential VPP. In this manner, by employing the charge pump circuit 100 described above in the semiconductor memory device 500 that uses the phase change element PC, it is possible to generate the boost power source VPP with a small occupied area and a high efficiency. Of course, if a higher boost potential VPP is required, the charge pump circuit 200, the charge pump circuit 300, or the charge pump circuit 400 can be used instead of the charge pump circuit 100.

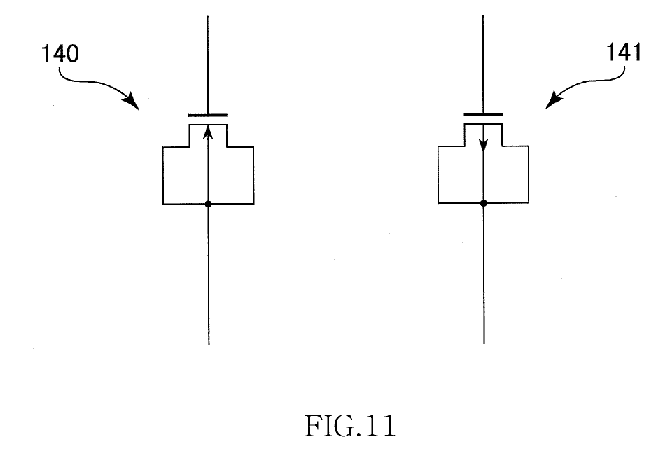

The capacitors in the above embodiments can be formed with a MOS transistor, as shown in FIG. 11. For example, the capacitor 111 shown in FIG. 1 can be formed with an NMOS transistor 140. One of the capacitor electrodes of the capacitor 111 is connected to a gate electrode, and the other of the capacitor electrodes is connected to a source, a drain, and a substrate. The same goes for the other capacitors. Further, when the capacitor 111 is formed with a PMOS transistor 141, one of the capacitor electrodes is connected to a source, a drain, and a substrate, and the other of the capacitor electrodes is connected to a gate electrode. For two or more capacitors, the capacitors can be configured by combining the NMOS transistor 140 and the PMOS transistor 141.

It is apparent that the present invention is not limited to the above embodiments, but may be modified and changed without departing from the scope and spirit of the invention.

What is claimed is:

1. A charge pump circuit comprising:
a plurality of capacitors including a first stage capacitor and a last stage capacitor connected in series via switch circuits;
a plurality of pre-charge circuits that pre-charge the capacitors, respectively; and
a control circuit that controls the switch circuits and the pre-charge circuits, wherein
the control circuit sequentially deactivates the pre-charge circuits from a pre-charge circuit assigned to the last stage capacitor to a pre-charge circuit assigned to the first stage capacitor in this order, such that the control circuit deactivates each of the pre-charge circuits after pre-charge of a parasitic capacitance component included in a latter stage capacitors with respect to a corresponding capacitor is completed, and
the control circuit supplies a drive signal to the first stage capacitor after the pre-charge circuit assigned to the first stage capacitor is deactivated so as to generate a boost voltage in the last stage capacitor.

2. The charge pump circuit as claimed in claim 1, wherein the control circuit steadily increases an interval between a timing at which a predetermined pre-charge circuit is deactivated and a timing at which a pre-charge circuit located at a stage ahead of the predetermined pre-charge circuit is deactivated.

3. The charge pump circuit as claimed in claim 1, wherein a current drive capability of a pre-charge circuit located at a relatively former stage is larger than a current drive capability of a pre-charge circuit located at a relatively latter stage.

4. The charge pump circuit as claimed in claim 1, further comprising a parallel capacitor connected to the last stage capacitor in parallel, wherein
the charge pump circuit generates the boost voltage in the last stage capacitor by pumping the parallel capacitor.

5. A charge pump circuit comprising:
N number of capacitors connected in series via switch circuits;
N number of pre-charge circuits that pre-charge the N number of capacitors, respectively; and
a control circuit that controls the switch circuits and the pre-charge circuits, wherein
the control circuit sequentially deactivates the pre-charge circuits from a first pre-charge circuit to an Nth pre-charge circuit in this order, and sets an interval between a timing at which an (i+1)th pre-charge circuit is deactivated and a timing at which an (i+2)th pre-charge circuit is deactivated to be longer than an interval between a timing at which an ith pre-charge circuit is deactivated and a timing at which the (i+1)th pre-charge circuit is deactivated, where is an integer from 1 to N−2.

6. A charge pump circuit comprising:
N number of capacitors connected in series via switch circuits;
N number of pre-charge circuits that pre-charge the N number of capacitors, respectively; and
a control circuit that controls the switch circuits and the pre-charge circuits, wherein
the control circuit sequentially deactivates the pre-charge circuits from a first pre-charge circuit to an Nth pre-charge circuit in this order, and
a current drive capability of a (j+1)th pre-charge circuit is larger than a current drive capability of a jth pre-charge circuit, where j is an integer from 1 to N−1.

7. A method generating a boost voltage by controlling a first capacitor including first and second terminals, a second capacitor including third and fourth terminals, and a switch circuit provided between the second and third terminals, the method comprising:
performing a first pre-charge of the first capacitor by supplying the first terminal with a first electrical potential and supplying the second terminal with a second electrical potential while the switch circuit is disconnected;
performing a second pre-charge of the second capacitor by supplying the third terminal with the first electrical potential and supplying the fourth terminal with the second electrical potential while the switch circuit is disconnected;
stopping the second pre-charge during performing the first pre-charge while the switch circuit is disconnected; and
connecting the switch circuit during performing the first pre-charge after stopping the second pre-charge.

8. The method as claimed in claim 7, further comprising stopping the first pre-charge after connecting the switch circuit.

9. The method as claimed in claim 8, further comprising supplying a drive signal to the first terminal so that the boost voltage appears at the fourth terminal.
